(19) United States
(12) Patent Application Publication
(10) Pub. No.: US 2024/0018963 A1
(43) Pub. Date: Jan. 18, 2024

(54) Material Mover

(71) Applicant: Paul Anthony Johnson, Columbia, MD (US)

(72) Inventor: Paul Anthony Johnson, Columbia, MD (US)

(73) Assignee: PADDLEMOVER LLC, Columbia, MD (US)

(21) Appl. No.: 18/038,735

(22) PCT Filed: Nov. 27, 2021
(86) PCT No.: PCT/US2021/060904

§ 371 Date: May 25, 2023

Related U.S. Application Data
(60) Provisional application No. 63/118,790, filed on Nov. 27, 2020.

(51) Int. Cl. F04D 5/00; F04D 13/06; F16H 29/12; F16H 37/12

(52) U.S. Cl. CPC F04D 5/00; F04D 13/06; F16H 29/12; F16H 37/12

(57) ABSTRACT

A material mover assembly, comprising a chamber having an inlet and an outlet; a first paddle; and a second paddle, wherein the first paddle is positioned in and configured to rotate circumferentially in the chamber, the second paddle is positioned in and configured to rotate circumferentially in the chamber, or is configured to be inserted into and retracted out of the chamber, and wherein relative motion of the first paddle and the second paddle causes material to be pulled into the chamber via the inlet and pushed out of the chamber via the outlet in a forward direction. A material mover assembly may be reversible in pumping direction and further may be used as an energy generator in either direction.

The disclosure is related to devices and methods to move materials including gases, gas/particulate mixtures, liquids, particulates and the like.

### BACKGROUND

Movers, or pumps, or blowers, may be employed to “move” or “pump” a gas, a liquid, a gas/particulate mixture, a liquid/particulate mixture, a solid particulate, and the like. Applications exist in many fields, such as medical (e.g. breathing assistance, pumping blood/fluids, or delivery of medicinal sprays), ventilation (e.g. ventilation of buildings, vehicles, specialized clothing, or helmets), industrial (e.g. petrochemical, food, or material processing), consumer (e.g. toys, engines, compressors, refrigeration, hair dryers, vacuum cleaners, portable fans), and energy (e.g. hydroelectric, pressure storage/release, wind/tide/wave power generation if pump is driven to generate energy).

Desired are more efficient apparatuses and methods for moving gases, fluids, particulates, and mixtures thereof. Desired are apparatuses to move materials in forward and backward directions.

Also desired are efficient apparatuses that may also work in either direction as power generators wherein a moving material is employed to generate energy which may be used immediately or, alternatively stored as mechanical or electrical energy.

As just one example, a material may be pumped in one direction to a higher energy state, and optionally allowed to flow in the opposite direction to generate work.

### SUMMARY

According, disclosed is a material mover assembly, comprising a chamber having an inlet and an outlet; a first paddle; and a second paddle, wherein the first paddle is positioned in and configured to rotate circumferentially in the chamber, the second paddle is positioned in and configured to rotate circumferentially in the chamber, or is configured to be inserted into and retracted out of the chamber, and wherein relative motion of the first paddle and the second paddle causes material to be pulled into the chamber via the inlet and pushed out of the chamber via the outlet in a forward direction. A “pulling and pushing” of a material may be thought of as a “positive displacement” of a material.

Also disclosed is a planetary gear assembly comprising a sun gear; a planetary gear stage; an outer ring gear; a drive shaft; and a variable speed assembly, wherein the variable speed assembly is coupled to the outer gear or the sun gear and configured to vary the rotation rate of the planetary gear stage in a repeatable and synchronized manner. In some embodiments, two or more variable speed assemblies may be configured together with a concentric output stage.

Also disclosed is an eccentric gear assembly, wherein the output comprises a repeatable and synchronized variable rotation rate. Two or more of such assemblies may be configured together with a concentric output stage.

Also disclosed is a differential gearbox configured so as to have one of its two outputs acted upon to achieve variable speed at two concentric outputs.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1 depicts a paddle wheel flow sensor.

FIG. 2A, FIG. 2B, FIG. 2C and FIG. 2D show a material mover according to an embodiment.

FIG. 3 depicts a portion of a material mover assembly, according to an embodiment.

FIG. 4 shows a material mover assembly, according to an embodiment.

FIG. 5 shows a paddle assembly, according to an embodiment.

FIG. 6 depicts a paddle and gearing assembly, according to an embodiment.

FIG. 7 illustrates a gearing assembly configured to operate from one side, according to an embodiment.

FIG. 8A, FIG. 8B, FIG. 8C, and FIG. 8D illustrate variable speed devices/assemblies, according to some embodiments.

FIG. 9 depicts a mover assembly portion having driving mechanics at one side, according to an embodiment.

FIG. 10A and FIG. 10B illustrate a mover assembly incorporating a variable speed gear assembly, having driving mechanics at one side, according to an embodiment.

### DETAILED DISCLOSURE

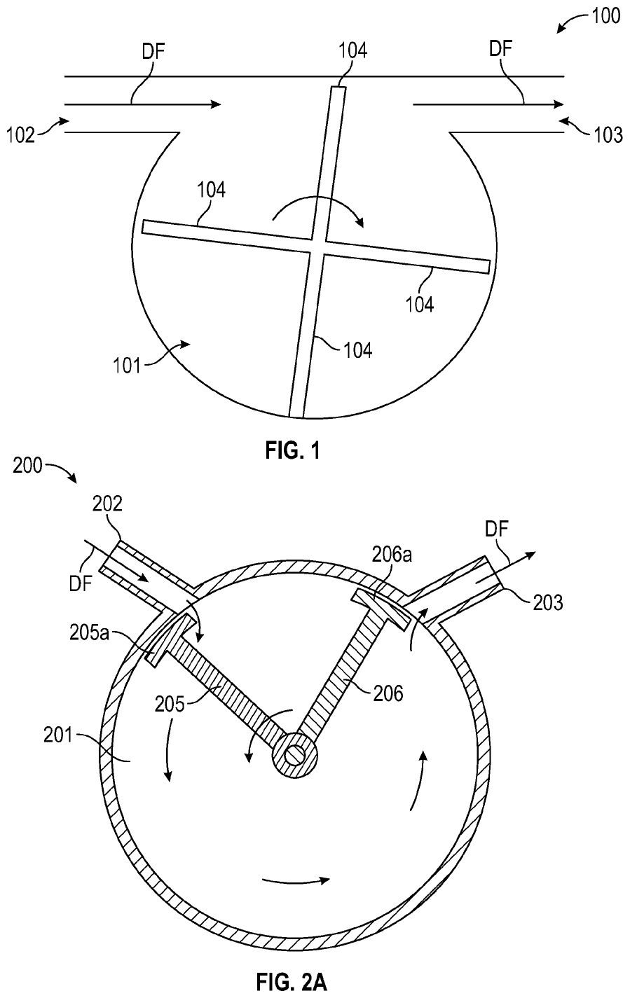

FIG. 1 shows a “paddle wheel” type flow sensor 100. Paddles 104 make up a paddle wheel and divide chamber 101 into four equal quadrants. In a flow sensor, liquid or gas will enter inlet 102, turn the paddle wheel and exit outlet 103. Rate of rotation of the paddle wheel may be used to determine a liquid or gas flow rate. Paddles 104 rotate together at an identical rate. Apparatus 100 will not be able to efficiently move a material into and out of chamber 101 in direction DF.

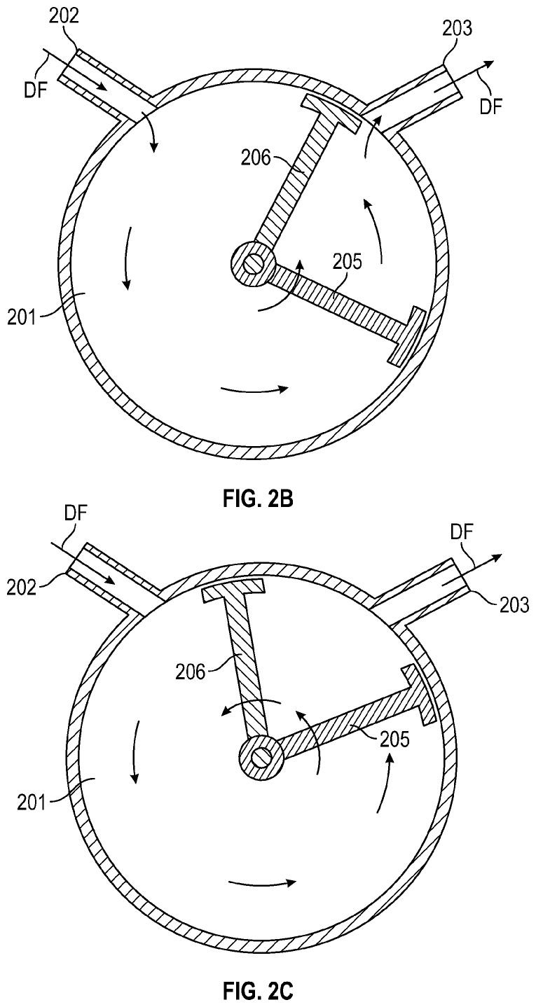

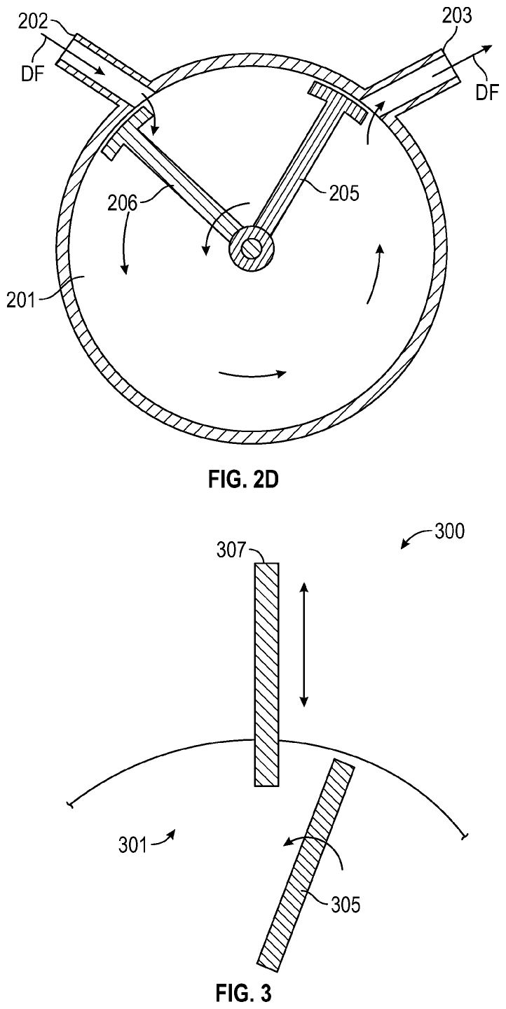

FIG. 2A, FIG. 2B, FIG. 2C and FIG. 2D show material mover apparatus 200 in different stages of paddle rotation through a rotation cycle, according to some embodiments. A rotation cycle may mean one full 360 degree rotation. Chamber 201 comprises a substantially cylinder-like shape. Alternatively, chamber 201 may comprise a sphere-like shape. First paddle 205 and second paddle 206 are positioned in chamber 201, are configured to rotate counter-clockwise, and to move a material through inlet 202, through chamber 201, and to exit outlet 203. Paddles 205 and 206 have arc-shaped ends or “feet” 205a and 206a, configured to align with an interior surface of chamber 201. Feet 205a and 206a may increase efficiency of material movement through chamber 201. In some embodiments, a paddle may comprise a rigid material and a flexible end material. In other embodiment, a paddle and an end may comprise a same rigid or a same flexible material. Feet 205a and 206a are configured to open and close inlet 202 and outlet 203, acting as sleeve valves. In FIG. 2A and FIG. 2B, second paddle 206 is stationary (static) or moving slowly at about a one o'clock position as first paddle 205 rotates counter-clockwise. As first paddle 205 approaches second paddle 206 (FIG. 2B), second paddle 206 begins to rotate counter-clockwise. FIG. 2C shows both first paddle 205 and second paddle 206 rotating at the same time. First paddle 205 will come to rest or be moving slowly at about a one o'clock position and be stationary or almost stationary for a majority of a rotation cycle of second paddle 206, repeating the pattern. Apparatus 200 moves a material, for example a liquid or a gas, efficiently through inlet in forward direction DF, through chamber 201, and out outlet 203 in direction DF. Inlet 202 and outlet 203 are radially aligned at an incident angle. In some embodiments, an assembly like 200 may comprise one or more further paddles, for example a third, and/or a fourth, and/or a fifth paddle.

FIG. 3 depicts a portion of material mover 300, according to an embodiment. In this embodiment, first paddle 305 is configured to rotate counter-clockwise in chamber 301 while second paddle 307 is positioned in chamber 301 at a 12 o'clock stationary position. As first paddle 305 approaches stationary second paddle 307, second paddle 307 is configured to retract from chamber 301, allowing first paddle to continue to rotate past the 12 o'clock position. Upon first paddle 305 passing the 12 o'clock position, second paddle 307 is configured to be re-inserted into chamber 301 to begin another rotation cycle.

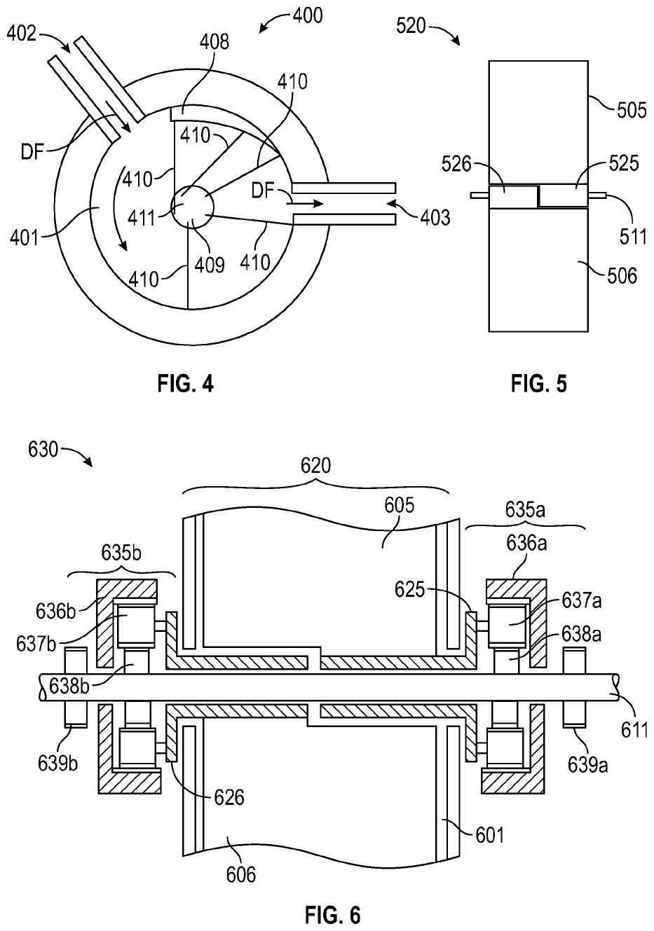

FIG. 4 illustrates material mover 400, according to another embodiment of the disclosure. Paddles 410 are coupled to central shaft 411 via a spring mechanism, and central shaft 411 is configured to rotate counter-clockwise at a constant rate. Upon rotation, paddles 410 are forced to climb wedge 408 incline, loading their spring mechanisms. When paddles 410 reach an end of wedge 408, paddles 410 are released and accelerate, pulling and pushing material in the counter-clockwise direction. As paddles are forced on wedge 408 their rate of rotation is slowed. The relative increased and decreased rate of rotation of paddles 410 to each other aids in directing a material in forward direction DF through inlet 402, through chamber 401 and out outlet 403. Inlet 402 and outlet 403 are not axially aligned, but alternatively could be, depending on the wedge length. In assembly 400, each paddle 410 is individually sprung. In an alternative embodiment, a central drive may have a torsional spring coupler.

FIG. 5 illustrates paddle assembly 520, according to an embodiment. Assembly 520 comprises first paddle 505 coupled to cylindrical hub 525, and second paddle 506 coupled to cylindrical hub 526. Hubs 525 and 526 are coupled to guide shaft 511. Cylinder-shaped hubs 525 and 526 allow paddles 505 and 506 to remain in close contact, minimizing by-pass leaks.

FIG. 6 illustrates mover assembly portion 630, according to an embodiment. Paddle assembly 620 comprising first paddle 605 coupled to hub 625, and second paddle 606 coupled to hub 626, is positioned in chamber 601. Hubs 625 and 626 (shown in cross-section) are coupled to planetary gear assemblies 635a and 635b, respectively, comprising external outer ring gears 636a/636b, planetary stage gears 637a/637b, and sun gears 638a/638b. Planetary stage gears 637a/637b drive paddles 605 and 606. Sun gears 638a and 638b are coupled to drive shaft 611. Assembly 635a and/or assembly 635b is configured to couple to a variable speed assembly. Drive wheels 639a/639b may be driven at a constant speed by drive shaft 611 together with sun gears 638a/638b. Drive wheels 639a/639b may be coupled to outer ring gears 636a/636b via a variable speed mechanism in order to make them oscillate, so offsetting cycle phases of planetary stages 637a and 637b to each other, providing a method to vary relative paddle positions during a rotation cycle. In another embodiment, a drive shaft may be coupled to an outer ring gear, and a variable speed assembly may be coupled to a sun gear.

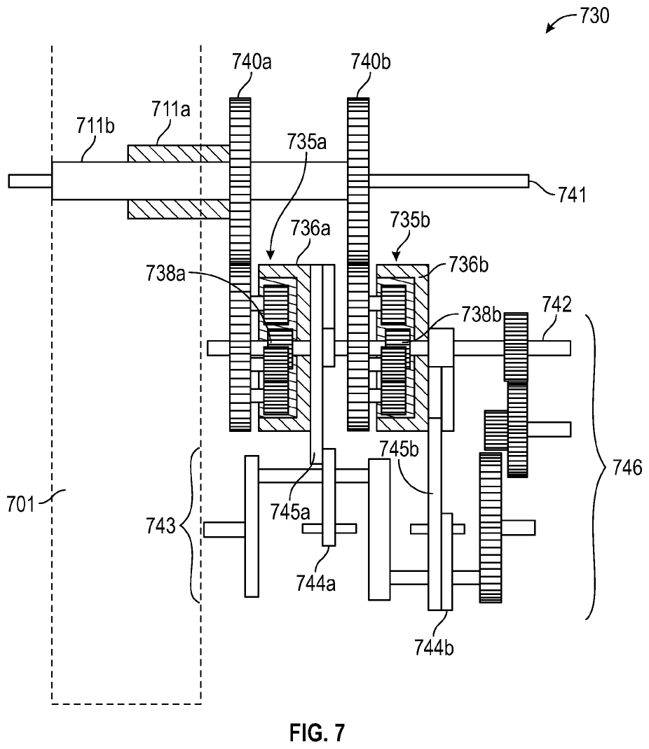

FIG. 7 shows mover assembly portion 730, according to an embodiment. Assembly 730 comprises two identical planetary gear sets 735a/735b on a same side of chamber 701. Planetary gear sets 735a/735b are paired with output gears 740a/740b. Output gears 740a/740b are paired with concentric output shafts 711a/711b. In an embodiment, assembly 730 comprises optional guide rod 741. Drive axis 742 is coupled to sun gears 738a/738b. Crankshaft assembly 743 comprises out-of-phase rocker arms 744a/744b coupled to connecting arms 745a/745b, which are themselves coupled to outer ring gears 736a/736b. Gear assembly 746 is configured to match a gear ratio of planetary sets 735a/735b. Connecting arms 745a/745b are configured to sweep ring gears 736a/736b back and forth, out-of-phase with each other, thus modifying output rotary speed of connected paddles (not shown) in chamber 701. Paddles will approach and distance from each other in a regular and repeatable manner.

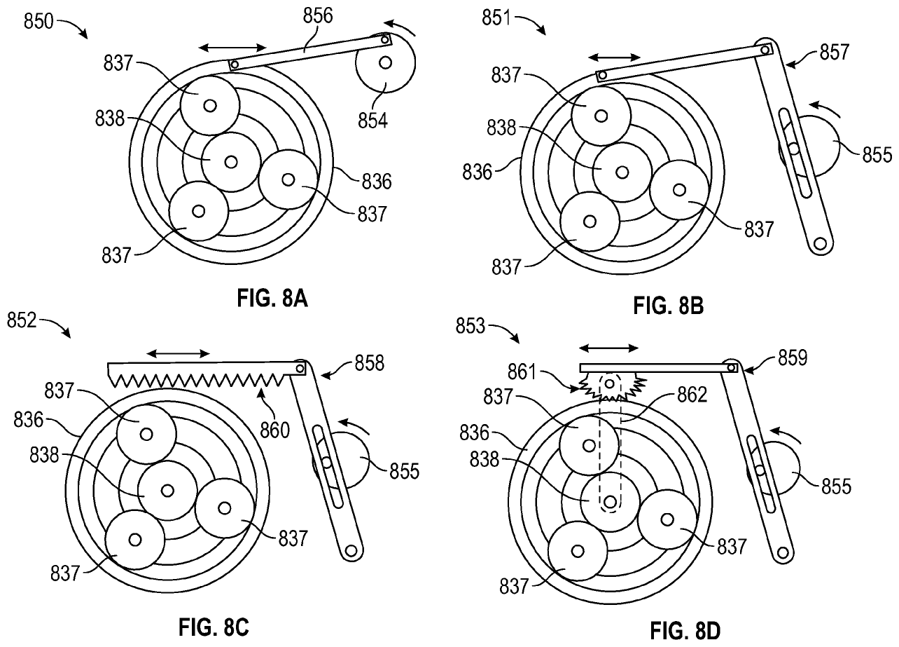

FIG. 8A, FIG. 8B, FIG. 8C, and FIG. 8D depict planetary gear variable speed assemblies 850, 851, 852, and 853 according to some embodiments. Devices 850, 851, 852, and 853 comprise sun gears 838, planetary gears 837, and ring gears 836 (gear teeth not shown). Drive wheels 854 and 855 are coupled to ring gears 836 via bar/rod 856 and multi-rod assemblies 857, 858, and 859 having pin/slot arrangements. Alternatively, a rack gear 860 may be employed. Rotation of drive wheels 854 and 855 provides a back-and-forth motion of ring gears 836, resulting in variable speed (oscillating) rotation rates of planetary gears 837. Devices 850, 851, 852, and 853 provide some methods of slowing and accelerating paddles without a need for disengagement and reengagement. Rod assemblies 858 and 859 comprise engagement teeth 860 and 861 to drive ring gears 836. Assembly 859 also contains support rod 862 to ensure proper positioning of teeth 861. In other embodiments, ring gears may be driven by arms or arm assemblies at a lower radial position.

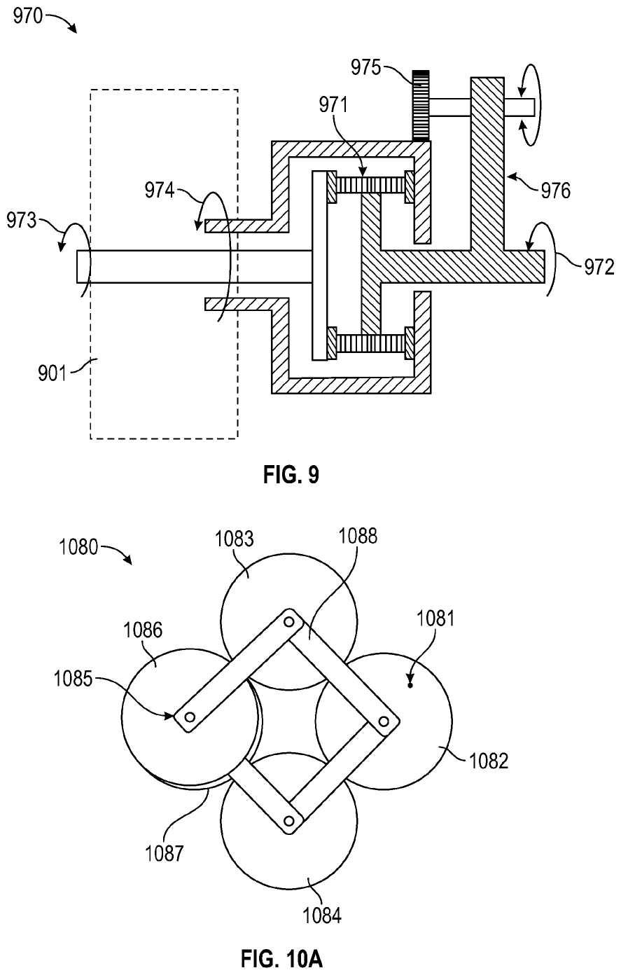

FIG. 9 illustrates mover assembly portion 970, according to an embodiment. Assembly 970 comprises all driving mechanics at one side. Differential gearbox 971 receives rotation input 972 and provides rotation output 973 and 974 to a first paddle and a second paddle (not shown) in chamber 901. Variable speed may be achieved with a separate drive on one side of a differential, or alternatively, may be geared to a main drive using a type of variable speed assembly. Input 972 may be coupled to gear 975 via arm assembly 976. Gear 975 is configured to rotate back and forth, thus providing variable speed of output 974 and 973 via the differential function. Assembly 970 may be configured so that a first paddle and a second paddle rotate with varying speed and are out-of-phase, so that a relative position of the paddles to each other will vary through a rotation cycle.

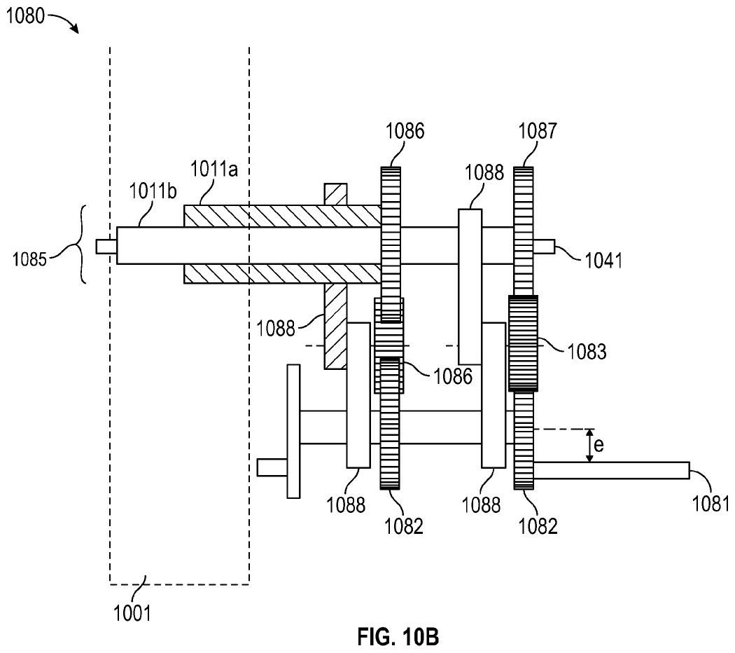

FIG. 10A depicts variable speed double eccentric gear assembly 1080, according to an embodiment. Assembly 1080 comprises eccentric gear 1082 having fixed drive axis 1081. Eccentric gear axis 1081 approaches transmitting gears 1083 and 1084 through different cycle angles, providing out-of-phase rotation. Transmitting gears 1083 and 1084 rotate gears 1086 and 1087 through two fixed concentric output axes 1085, allowing all driving from one side of a mover assembly. Pinned arms 1088 assure different gears (teeth not shown) are maintained at correct distancing. In an alternative embodiment, transmitting gears may be alongside each other rather than in upper and lower positions. Transmitting gears alongside each other may have different diameters, thus producing an out-of-phase output.

FIG. 10B provides a top view of variable speed gear assembly 1080, according to an embodiment. Input drive 1081 is eccentric to gear 1082 axis. Input drive 1081 rotates on its axis and gear 1082 moves in an eccentric (e) fashion. Optional floating guide rod 1041 provides for alignment and may act as a bearing. Output gears 1086 and 1087 are coupled to concentric output shafts 1011a and 1011b. Out-of-phase rotation is provided to paddles (not shown) in chamber 1001.

In some embodiments, it is not required for one paddle to be static or nearly static during a rotation pattern. In some embodiments, a smoother, e.g. sinusoidal, relative rotation of paddles may be employed.

A chamber may comprise a single inlet and a single outlet, or may comprise multiple inlets and/or outlets. An inlet may be axially aligned with an outlet, or may not be axially aligned. In some embodiments, a chamber may comprise a substantially cylinder-like shape. In other embodiments, a chamber may comprise a substantially sphere-like shape.

In some embodiments, a mover assembly comprises a first paddle, a second paddle, and optionally one or more further paddles configured to be positioned in a chamber and to rotate circumferentially in the chamber. In other embodiments, a mover assembly comprises a first paddle, a second paddle, and one or more further paddles, wherein one or more of the paddles is configured to be inserted into and retracted out of the chamber, and wherein the other paddle(s) are configured to rotate circumferentially in the chamber.

A relative motion of the first paddle and the second paddle causes material to be pulled into the chamber via the inlet and pushed out of the chamber via the outlet in a forward direction.

In some embodiments, as a first paddle rotates, a second paddle is static or nearly static for at least a portion of a first paddle rotation cycle, and wherein as the second paddle rotates, the first paddle is static or nearly static for at least a portion of a second paddle rotation cycle.

In some embodiments, a first and/or second paddle may be configured to rotate at a varying rate of speed over a rotation cycle. A rotation cycle may mean a full 360 degree cycle of a single paddle, or may mean completion of a 360 degree rotation of all paddles of an assembly.

In some embodiments, one paddle may be configured to rotate at a constant rate of speed, while a further paddle may rotate at a varying rate of speed. In some embodiments, a first and a second paddle may both rotate at different, constant rates, and may switch off from fast to slow and from slow to fast, respectively, when one approaches the other.

In some embodiments, a paddle variable rotation rate may occur over a pre-determined set repeating pattern.

In some embodiments, a material mover assembly may comprise a drive shaft and/or a gear assembly. In some embodiments, a drive shaft may be driven via an electric motor. A mover assembly may comprise a step motor or servo motor.

In some embodiments, varying rates of paddle rotation may be achieved with a clutch mechanism to engage/disengage a gear assembly. In other embodiments, varying rates of paddle rotation may be accomplished without engagement/disengagement of a gear assembly. In some embodiments, this may be accomplished with a planetary/epicyclic gear assembly, an eccentric gear set, or a differential gear set.

In some embodiments, a first paddle and a second paddle may be independently driven, or alternatively, may be conjointly driven.

In some embodiments, a paddle rotation direction may be configured to be reversible, a reversible rotation direction causing material to be pulled into the chamber via the outlet and pushed out of the chamber via the inlet in a reverse direction. In some embodiments, paddle rotation in a reverse direction may be configured to store energy, for instance to store energy in a battery or in the form of a spring. This may be achieved for example via a hand crank mechanism or a repetitive ratchet type mechanism. In some embodiments, a certain number of repetitive actuations may pump a material in a reverse direction, and a further actuation may release the material in a forward direction. In some embodiments, a reverse direction may be employed to store material for later release.

In some embodiments, a move assembly may be configured to reverse a direction of operation. A mover assembly may be configured such that material may drive paddles to provide for storage of mechanical or electrical energy.

In some embodiments, driving a material in one direction may provide storing of energy which may be used to drive a material back in an opposite direction. For instance, if a person blows into the device, in some embodiments, the paddles will automatically sort themselves out to follow a cycle where the paddles move at variable relative speed to each other and therefore give an output (to what is the drive shaft when used in a pumping direction) at a near constant rotation speed.

In some embodiments, a mechanism may be employed to aid in storing energy, for example a spring or clockspring mechanism. In some embodiments, a storing mechanism may comprise a release feature, for instance a latch, or the like, configured to be actuated to release material energy causing material to be pulled into the chamber via the inlet and pushed out of the chamber via the outlet in a forward direction. In some embodiments, a mechanism may be configured to store mechanical and/or electrical energy and to release the energy on demand.

In some embodiments, a material mover assembly may be configured to provide substantially a same material flow rate in the forward and the reverse directions. In other embodiments, a material mover assembly may be configured to provide different material flow rates in the forward and the reverse directions. Such a configuration may be employed for instance for a patient having weak inhalation and normal exhalation.

In some embodiments, a material mover may be configured to provide same or different material volumes over a rotation cycle or over a number or rotation cycles in a forward and a reverse direction.

In some embodiments, an assembly may comprise one or more one-way valve to aid in adjusting, amplifying, or reducing material flow rates and/or volumes.

In some embodiments, a first paddle and/or a second paddle may comprise a flexible end or edge in contact with an interior surface of the chamber. This may aid in providing a highly efficient mover by reducing any back-flow. In some embodiments, a material may enter and exit a chamber at a substantially constant, steady flow rate with little turbulence. In some embodiments, a paddle may comprise a rigid material and a flexible end material. In other embodiments, a paddle and an end may comprise a same rigid or a same flexible material. In some embodiments, a flexible end or rigid end may comprise an “arc” shape to aid in opening or closing of inlets/outlets, acting as a sleeve valve.

In some embodiments, a present device or assembly may be employed for example in place of an air fan. A present device may be employed in a breathing apparatus, air ventilation system, an air pump, water pump, medical device (e.g. inhaler), space/diving helmet, refrigeration, etc. In an embodiment, a device may be employed to move air in one direction, wherein the air may be mixed with a medicine to be inhaled, and moved back in the opposite direction to be inhaled by a patient.

In some embodiments, two or more present material mover assemblies may be coupled in a parallel or series (i.e. “stacked”).

Also disclosed is a planetary gear assembly comprising a sun gear; a planetary gear; an outer (ring) gear; a drive shaft; and a variable speed assembly, wherein the variable speed assembly is coupled to the outer gear or the sun gear and configured to vary the rotation rate of the planetary gear stage.

In some embodiments, a variable speed assembly comprises a drive wheel and rod, or wheel and rack, wherein the rod is coupled to the drive wheel and the outer gear or sun gear. In some embodiments, a rod may comprise a multi-rod assembly.

In some embodiments, a drive shaft drives the sun gear or outer gear and the variable speed assembly drive wheel at a constant rotation rate of speed. The variable speed assembly may move the outer gear or sun gear in a back-and-forth position, thereby varying the rotation rate of the planetary gear.

In some embodiments, paddle rotation patterns may be adjustable. For example rotation patterns may be adjusted to vary pressure/flow characteristics, for example high pressure compression at low flow rates or low pressure at high flow rates. For example, in a case where an arc-shaped paddle end closes an outlet in a static position, pressure may increase upon rotation of another paddle. Pressure may be controlled via relative position of one or more paddles.

In some embodiments, intentional backlash or similar slack of paddle positions may be intelligently used to help in re-positioning paddles with respect to inlets and outlets, used to optimize when changing pumping or energy generating directions. This re-positioning may be assisted by pressure, inertia, spring loading, friction or manual/automated actuation and might be constant in an application or temporary/intermittent depending on cycle position or whether in load change, speed change, start-up or slow down.

In some embodiments, an assembly may comprise a plurality of paddles configured to work in a “caterpillar”, or concerted “daisy-chain” way, wherein an assembly may comprise bypass cavities or tunnels wherein material may be pushed in and out with paddle feet acting to close and open the bypass cavities. Bypass cavities may be used to increase pressure in steps throughout a rotation cycle.

In some embodiments, a mover may drive a material in a first direction or a second direction, and may also act as an energy generator in a first or a second direction if driven by a material. In some embodiments, a first direction is opposite to a second direction.

Following are some non-limiting embodiments of the disclosure.

In a first embodiment, disclosed is a material mover assembly, comprising a chamber having an inlet and an outlet; a first paddle; and a second paddle, wherein the first paddle is positioned in and configured to rotate circumferentially in the chamber, the second paddle is positioned in and configured to rotate circumferentially in the chamber, or is configured to be inserted into and retracted out of the chamber, and wherein a relative motion of the first paddle and the second paddle causes material to be pulled into the chamber via the inlet and pushed out of the chamber via the outlet in a forward direction.

In a second embodiment, disclosed is a mover assembly according to the first embodiment, wherein the first paddle and the second paddle are positioned in and configured to rotate circumferentially in the chamber. In a third embodiment, disclosed is a mover assembly according to the second embodiment, wherein as the first paddle rotates, the second paddle is static or nearly static for at least a portion of a first paddle rotation cycle, and wherein as the second paddle rotates, the first paddle is static or nearly static for at least a portion of a second paddle rotation cycle.

In a fourth embodiment, disclosed is a mover assembly according to embodiments 2 or 3, wherein the first paddle and/or the second paddle are configured to rotate at a varying rate over a rotation cycle. In a fifth embodiment, disclosed is a mover assembly according to embodiments 2 or 3, wherein the first paddle and the second paddle are configured to rotate at a varying rate over a rotation cycle.

In a sixth embodiment, disclosed is a mover assembly according to any of embodiments 2 to 4, wherein the first paddle and/or the second paddle are configured to rotate at a constant rate over a rotation cycle. In a seventh embodiment, disclosed is a mover assembly according to embodiments 2 or 3, wherein the first paddle and the second paddle are configured to rotate at constant, different rates over a rotation cycle. In an eighth embodiment, disclosed is a mover assembly according to embodiments 4 and 5, wherein the varying rate is configured to occur in a set repeating pattern over a rotation cycle.

In a ninth embodiment, disclosed is a mover assembly according to the first embodiment, wherein the first paddle is positioned in and configured to rotate circumferentially in the chamber and the second paddle is configured to be inserted into and retracted out of the chamber.

In a tenth embodiment, disclosed is a mover assembly according to any of the preceding embodiments, comprising an electric motor. In an eleventh embodiment, disclosed is a mover assembly according to any of the preceding embodiments, comprising a step motor or a servo motor. In a twelfth embodiment, disclosed is a mover assembly according to any of the preceding embodiments, comprising a clutch mechanism.

In a thirteenth embodiment, disclosed is a mover assembly according to any of the preceding embodiments, comprising a gear assembly. In a fourteenth embodiment, disclosed is a mover assembly according to any of the preceding embodiments, comprising a planetary/epicyclic gear assembly.

In a fifteenth embodiment, disclosed is a mover assembly according to any of the preceding embodiments, wherein movement of the first paddle and the second paddle are independently driven. In a sixteenth embodiment, disclosed is a mover assembly according to any of embodiments 1 to 14, wherein movement of the first paddle and the second paddle are conjointly driven.

In a seventeenth embodiment, disclosed is a mover assembly according to any of the preceding embodiments, wherein a paddle rotation direction is reversible, the reversible rotation direction causing material to be pulled into the chamber via the outlet and pushed out of the chamber via the inlet in a reverse direction. In an eighteenth embodiment, disclosed is a mover assembly according to embodiment 17, wherein paddle rotation in the reverse direction is configured to store energy. In a nineteenth embodiment, disclosed is a mover assembly according to embodiment 18, comprising a mechanism, for example a spring or clockspring, configured to store material energy.

In a twentieth embodiment, disclosed is a mover assembly according to embodiments 18 or 19, comprising a mechanism, for example a latch, configured to be actuated to release material energy causing material to be pulled into the chamber via the inlet and pushed out of the chamber via the outlet in the forward direction. In a twenty-first embodiment, disclosed is a mover assembly according to any of embodiments 17 to 20, wherein the assembly is configured to provide substantially a same material flow rate in the forward and the reverse directions.

In a twenty-second embodiment, disclosed is a mover assembly according to any of embodiments 17 to 20, wherein the assembly is configured to provide different material flow rates in the forward and the reverse directions. In a twenty-third embodiment, disclosed is a mover assembly according to any of embodiments 17 to 22, wherein the assembly is configured to provide different material volumes over a rotation cycle or over a number or rotation cycles in the forward and the reverse direction.

In a twenty-fourth embodiment, disclosed is a mover assembly according to any of the preceding embodiments, comprising a one-way valve. In a twenty-fifth embodiment, disclosed is a mover according to any of the preceding embodiments, wherein the inlet and the outlet are axially aligned. In a twenty-sixth embodiment, disclosed is a mover according to any of embodiments 1 to 24, wherein the inlet and the outlet are not axially aligned.

In a twenty-seventh embodiment, disclosed is a mover according to any of the preceding embodiments, wherein the material enters and exits the chamber at a substantially constant flow rate. In a twenty-eighth embodiment, disclosed is a mover according to any of the preceding embodiments, wherein the first paddle and/or the second paddle comprises a flexible end in contact with an interior surface of the chamber.

In a twenty-ninth embodiment, disclosed is a mover according to any of the preceding embodiments, comprising one or more further paddles positioned within the chamber and configured to rotate circumferentially within the chamber.

In a thirtieth embodiment, disclosed is a mover according to any of the preceding embodiments, wherein the chamber comprises a substantially cylinder-like shape. In a thirty-first embodiment, disclosed is a mover according to any of the preceding embodiments, wherein the chamber comprises a substantially sphere-like shape.

In a thirty-second embodiment, disclosed is a mover according to any of the preceding embodiments, wherein the material is one or more of a gas, a gas/particulate mixture, a liquid, or a particulate solid.

In a thirty-third embodiment, disclosed is a planetary gear assembly comprising a sun gear; a planetary gear; an outer (ring) gear; a drive shaft; and a variable speed assembly, wherein the variable speed assembly is coupled to the outer gear or the sun gear and configured to vary the rotation rate of the planetary gear. In a thirty-fourth embodiment, disclosed is a planetary gear assembly according to embodiment 33, wherein the variable speed assembly is coupled to the outer ring gear.

In a thirty-fifth embodiment, disclosed is a planetary gear assembly according to embodiment 33, wherein the variable speed assembly is coupled to the sun gear. In a thirty-sixth embodiment, disclosed is a planetary gear assembly according to any of embodiments 33 to 35, wherein the variable speed assembly comprises a drive wheel and rod, wherein the rod is coupled to the drive wheel and the outer gear or sun gear. In a thirty-seventh embodiment, disclosed is a planetary gear assembly according to embodiment 36, wherein the rod comprises a multi-rod assembly.

In a thirty-eighth embodiment, disclosed is a planetary gear assembly according to embodiments 36 or 37, wherein the drive shaft drives the sun gear or outer gear and the variable speed assembly drive wheel. In a thirty-ninth embodiment, disclosed is a planetary gear assembly according to any of embodiments 33 to 38, wherein the variable speed assembly is configured to move the outer gear or sun gear in a back-and-forth position, thereby varying the rotation rate of the planetary gear.

In a fortieth embodiment, disclosed is an assembly as described herein, wherein the motor employed to drive a material in a first direction, may be used as a dynamo when the assembly is driven by a material in an opposite direction.

The term “adjacent” may mean “near” or “close-by” or “next to”.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The term “flow communication” means for example configured for liquid or gas flow there through and may be synonymous with “fluidly coupled”. The terms “upstream” and “downstream” indicate a direction of gas or fluid flow, that is, gas or fluid will flow from upstream to downstream.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90° ”. The term “generally” may be equivalent to “substantially”.

The term “nearly” may mean “almost”

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. A material mover assembly, comprising
a chamber having an inlet and an outlet;
a first paddle; and
a second paddle,
wherein
the first paddle is positioned in and configured to rotate circumferentially in the chamber,
the second paddle is positioned in and configured to rotate circumferentially in the chamber, or is configured to be inserted into and retracted out of the chamber, and
wherein a relative motion of the first paddle and the second paddle causes material to be pulled into the chamber via the inlet and pushed out of the chamber via the outlet in a forward direction.

2. The mover assembly according to claim 1, wherein the first paddle and the second paddle are positioned in and configured to rotate circumferentially in the chamber.

3. The mover assembly according to claim 2, wherein the first paddle and the second paddle rotate at a varying rate, and wherein, as the first paddle rotates, the second paddle is static or nearly static for at least a portion of a first paddle rotation cycle, and wherein as the second paddle rotates, the first paddle is static or nearly static for at least a portion of a second paddle rotation cycle.

4. The mover assembly according to claim 3, wherein the varying rate is configured to occur in a repeating pattern over a rotation cycle.

5. The mover assembly according to claim 4, wherein the assembly comprises a step motor or a servo motor, and wherein the rotation cycle repeating pattern is electronically controlled.

6. The mover assembly according to claim 4, wherein the assembly comprises a constant speed electric motor and a gear assembly, and wherein the gear assembly is configured to control the rotation cycle repeating pattern.

7. The mover assembly according to claim 4, comprising an eccentric gear assembly and a concentric output drive assembly, wherein the eccentric gear assembly and the concentric output drive assembly is configured to control the rotation cycle repeating pattern.

8. The mover assembly according to claim 4, comprising a planetary/epicyclic gear assembly, configured to control the rotation cycle repeating pattern.

9. The mover assembly according to claim 4, comprising a differential gearbox, configured to control the rotation cycle repeating pattern.

10. The mover assembly according to claim 4, wherein the rotation cycle repeating pattern is adjustable.

11. The mover assembly according to claim 1, wherein a paddle rotation direction is reversible, the reversible rotation direction configured to pull material into the chamber via the outlet and to push out of the chamber via the inlet in a reverse direction.

12. The mover assembly according to claim 11, wherein paddle rotation is driven by material flow to create mechanical or electrical energy.

13. The mover assembly according to claim 11, comprising a mechanism configured to store energy and configured to release the energy on demand.

14. The mover according to claim 1, wherein the first paddle and/or the second paddle comprises a flexible end in contact with an interior surface of the chamber.

15. The mover according to claim 1, wherein the material is one or more of a gas, a gas/particulate mixture, a liquid, or a particulate solid.

16. The mover assembly according to claim 1, wherein the first paddle is positioned in and configured to rotate circumferentially in the chamber and the second paddle is configured to be inserted into and retracted out of the chamber.

17. A planetary gear assembly comprising
a sun gear;
a planetary gear stage;
an outer ring gear;
a drive shaft; and
a variable speed assembly,
wherein the variable speed assembly is coupled to the outer ring gear or the sun gear and configured to vary the rotation rate of the planetary gear stage.

18. The planetary gear assembly according to claim 17, wherein the variable speed assembly comprises a drive wheel and rod, wherein the rod is coupled to the drive wheel and the outer ring gear or sun gear.

19. The planetary gear assembly according to claim 18, wherein the drive shaft drives the sun gear or outer ring gear and the variable speed assembly drive wheel.

20. The planetary gear assembly according to claim 17, wherein the variable speed assembly is configured to move the outer ring gear or sun gear in a back-and-forth position, thereby varying the rotation rate of the planetary gear stage.
